(19) United States
(12) Patent Application Publication
(10) Pub. No.: US 2007/0133127 A1
(43) Pub. Date: Jun. 14, 2007

(54) Leader or cartridge attached tape head cleaning brush

(75) Inventors: Stephen J. Stamm, Fort Lupton, CO (US); William E. Faulkner, Broomfield, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/304,802

(22) Filed: Dec. 14, 2005

(51) Int. Cl. G11B 5/41

(52) U.S. Cl. 360/128

(57) ABSTRACT

A cartridge is provided for cleaning a tape drive head. The cartridge includes a flexible member (e.g., a cartridge leader or tape portion) adapted for use with a tape drive and having a cleaning brush fixed thereto. The cleaning brush may be flexible and include a plurality of bristles for contacting and removing debris from the drive head, and in particular, from grooves or slots of the drive head. In another aspect a tape drive is provided, the tape drive including a flexible member (e.g., a drive leader) having a cleaning brush fixed thereto for contacting and cleaning the drive head.

### BACKGROUND

1. Field

The present invention relates generally to apparatuses, systems, and methods for cleaning tape drive heads. In one particular example, the present invention relates to a cleaning brush attached to a drive leader or cartridge tape or leader for cleaning a tape drive head.

2. Related Art

Magnetic tape cartridges have proven to be an efficient and effective medium for data storage in computer systems. Magnetic tape cartridge storage systems generally include one or more tape cartridges housing a tape coated with a magnetic medium and one or more tape drives. A tape drive typically includes a data transducer, e.g., a read and/or write head, and various control electronics for writing data to the magnetic tape and reading data from the magnetic tape and for moving the data transducer laterally with respect to the tape.

The data transducer heads in the tape drive may experience a build up of debris or contaminants over time. The build up of debris on the data transducer heads may cause a decrease in performance or damage to the tape drive and/or magnetic storage tape. Various devices and methods for cleaning transducer heads have been provided. For example, an apparatus may be housed with the tape drive for selectively moving a cleaning pad to engage and clean the drive head of debris. For example, U.S. patent Ser. No. 6,751,056, discloses a head cleaning pad disposed on a carrier for selectively engaging and cleaning the drive head (the entire content of which is incorporated by reference herein). Such a device, however, uses valuable space within the drive housing, may be prone to mechanical failures, and may require undesirable maintenance to periodically clean or replace the cleaning pad.

In other examples, a cartridge housing a cleaning tape, commonly referred to as a “cleaning cartridge,” may be used. A cleaning cartridge may include a tape that is manufactured with particular mechanical and/or chemical properties that provide for increased abrasiveness to clean debris from the transducer head of the drive. The cleaning cartridge may be loaded into the tape drive and spooled across a transducer head thereby removing debris and contaminants.

Conventional cleaning cartridges, however, generally do not provide a cleaning portion that removes debris from within grooves or slots of the tape drive head, thereby decreasing the performance of the tape drive head. For example, a head may include grooves for specific performance issues, such as air bleeding or the like, and as the grooves are filled with debris the performance may suffer.

### BRIEF SUMMARY

In one aspect of the present invention an apparatus for cleaning a tape drive transducer head is provided. In one example, the apparatus includes a flexible member (e.g., a drive leader, cartridge leader, storage tape, etc.) adapted for use with a storage tape drive. The flexible member has a cleaning brush fixed thereto, wherein the cleaning brush includes a plurality of bristles. The cleaning brush may be positioned to contact a tape drive head such that the bristles of the cleaning brush reach into grooves or slots of the drive head and remove debris therefrom. Further, in one example, the cleaning brush is itself flexible and may conform to the contours of the drive head.

In one example, the cleaning brush is fixed to a cartridge leader, tape portion, or other flexible member of a cartridge. A drive may engage the cartridge leader and move the cleaning brush to a position to contact and clean the drive head. In another example, the cleaning brush is fixed to a drive leader, wherein the drive selectively positions the cleaning brush to contact and clean the drive head. The flexible member may further include a cleaning member (similar or dissimilar to the cleaning brush) positioned on a side of the flexible member opposite the cleaning brush, which may be used to clean a portion of an optical servo system or the like.

In one example, the bristles of the cleaning brush have a height relative to the flexible member of less than 0.1 inches. In other examples, the height is equal to or less than 0.05 inches, and in yet other examples, the height is equal to or less than 0.03 inches.

In another aspect of the present invention a cleaning cartridge is provided. The cleaning cartridge includes a flexible member (e.g., a cartridge leader or storage tape) adapted for use with a tape drive and a cleaning brush fixed to the flexible member. The cleaning brush may include a plurality of bristles and is flexible to conform to the contours of the drive head.

In another aspect of the present invention a tape drive is provided. The tape drive includes a flexible member (e.g., a drive leader) having a cleaning brush fixed to the flexible member. The cleaning brush includes a plurality of bristles and is flexible to conform to the contours of the drive head.

In another aspect of the present invention, a method for cleaning a drive head is provided. In one example the method includes moving a flexible cleaning brush to a position adjacent a drive head, the flexible cleaning brush associated, for example, with a drive leader or a portion of a cartridge leader or tape portion. The method may further include moving the head relative to the cleaning brush.

The present inventions and various aspects are better understood upon consideration of the detailed description below in conjunction with the accompanying drawings and claims.

### BRIEF DESCRIPTION OF THE DRAWINGS

FIG. 1 illustrates an exemplary tape drive and an exemplary cleaning cartridge;

FIG. 2A illustrates an exemplary cartridge including a cleaning brush fixed to the cartridge leader and/or a tape portion;

FIG. 2B illustrates a cross-sectional view of a portion of the cartridge leader and/or a tape portion including the cleaning brush fixed thereto;

FIGS. 3A-3D illustrate various configurations of a cleaning brush fixed to a flexible member such as a cartridge leader and/or a tape portion associated with a cartridge or tape drive; and

FIG. 4 illustrates a cross-sectional view of an exemplary cartridge leader and/or a tape portion including a cleaning brush affixed to a first side and a cleaning member fixed to an opposite second side.

### DETAILED DESCRIPTION

The following description is presented to enable any person of ordinary skill in the art to make and use the various aspects and examples of the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

In one example, an apparatus for cleaning a tape drive head includes a flexible cleaning brush mounted to a flexible member associated with a tape drive or tape cartridge. For example, the flexible member may include a drive leader, cartridge leader, storage tape, or other flexible member that may be moved through the tape drive along a path adjacent the tape drive head. In operation, the flexible member and cleaning brush are moved through the tape drive to a position to clean the drive head and remove debris. Additionally, in one example, when the cleaning brush is positioned at the drive head, the drive head may be actuated, e.g., moved relative to the cleaning brush, to further facilitate cleaning.

The cleaning brush is sufficiently flexible to be moved (or “streamed”) through the tape drive along the tape path and may generally conform to contours of the media head. In one example, the cleaning brush includes a plurality of bristles having a height relative to the flexible member of less than 0.1 inches; in another example equal to or less than 0.05 inches; and in another example equal to or less than 0.03 inches.

The cleaning brush may include a plurality of fibers or bristles integrated into and projected generally away from a backing or the flexible member by, for example, sewing, weaving, bonding or otherwise fixing the fibers in place. In one example, the fibers and/or backing are made from electrically conductive or statically dissipative materials to minimize electrostatic charge build-up, thereby protecting transducer elements of the head.

Other cleaning materials, such as cloth pads, abrasive materials (such as aluminum oxide), and the like generally do not reach into grooves and slots commonly present in tape drive heads. Additionally, in some instances such cleaning materials may deposit material within grooves of the tape drive head. In contrast, a cleaning brush as described, comprising a plurality of bristles, may extend into the grooves and slots of the drive head and remove such debris.

Further, in examples where the cleaning brush is included with a cartridge, a new cartridge having a new cleaning brush may be easily used after a predetermined number of usages to increase the effectiveness of cleaning. Further, such examples eliminate the issues of having to replace a drive integrated cleaning brush.

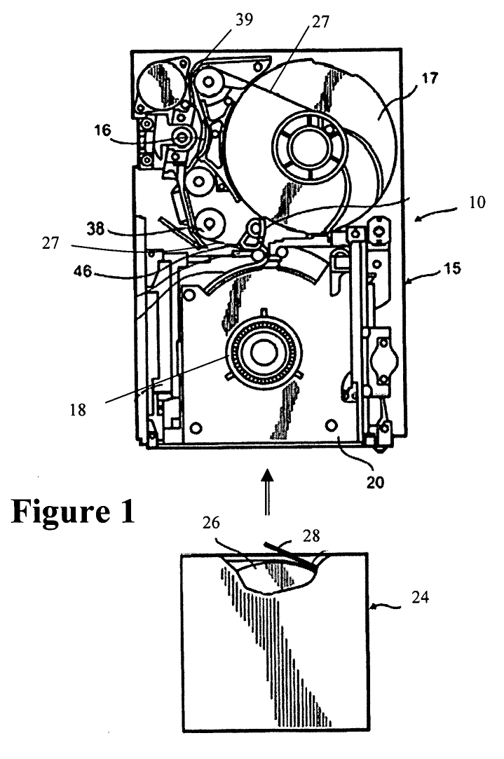

Referring initially to FIG. 1, an exemplary tape drive 10 is illustrated that may be used with an exemplary cartridge 24. Tape drive 10 is typically installed within or associated with a computer system (not shown) or computer network. Tape drive 10 includes a tape drive housing 15, a data transducer, i.e., read and/or write head 16, a take-up reel 17, and a receiver slot 20. Tape drive 10 is used in conjunction with cartridge 24, which may include a cartridge having a cleaning brush (not shown) as described herein, and which includes a cartridge leader 28 and supply reel 26. Receiver slot 20 is configured to receive a suitable cartridge 24 therein adjacent reel driver 18. Tape drive 10 may also include a door and various mechanisms for receiving and ejecting cleaning cartridge 24.

When cartridge 24 is received in receiver slot 20 a buckler motor 46 or the like engages cartridge leader 28 to couple the drive leader 27 to cartridge leader 28, and stream cartridge leader 28 from cartridge 24 along a path within tape drive 10 passing read/write head 16. The path may include various tape guides 39, rollers 38, one or more read/write heads 16, and the like before being wound upon take-up reel 17.

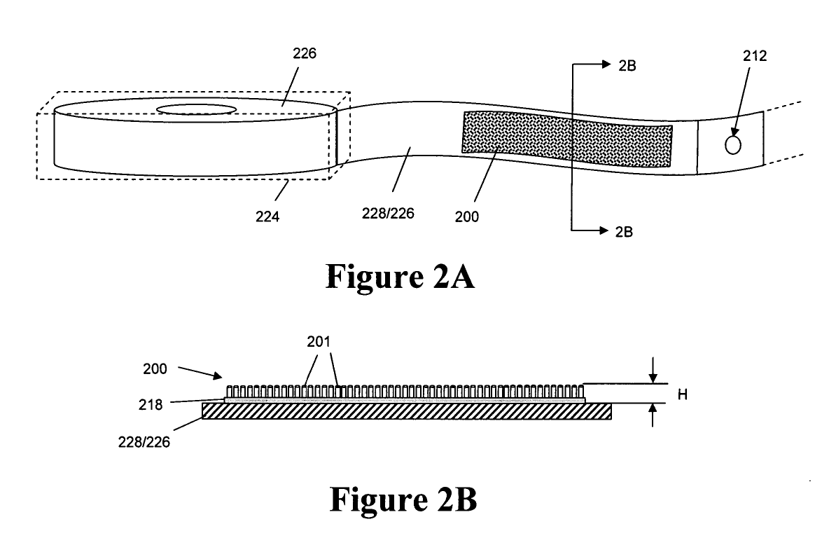

Cartridge 24 generally includes a substantially rectangular cartridge housing which encloses cartridge reel 26 and cartridge leader 28. Cartridge 24 may further include a cartridge door to protect cartridge leader 28, cleaning brush(es), tape, etc. when not in use. In this example, cartridge 24 includes a flexible cleaning brush (not shown in FIG. 1; see, for example, FIG. 2A and cleaning brush 200) associated with cartridge leader 28 and/or tape wound on cartridge reel 26. As drive 10 engages and streams cartridge leader 28 through drive 10, the cleaning brush is moved to a position adjacent head 16, and in particular to a position to contact and clean head 16. A controller (not shown) may operate to control the movement of cartridge leader 28 and the cleaning brush to a suitable position, and may further operate to move head 16, e.g., up and down, to further enhance the cleaning process.

In another example, a cleaning brush may be included with drive leader 27 such that drive 10 may perform cleaning processes without the need for a cartridge 24 including a cleaning brush associated therewith. For example, a cleaning brush could be positioned with drive leader 27 such that head 16 may be cleaned when a cartridge is loaded or unloaded from the drive. In one example, the cleaning brush may be positioned on drive leader 27 such that when buckle 46 is positioned as shown in FIG. 1, e.g., to receive a cartridge leader pin, the cleaning brush is aligned with head 16. Other positions along drive leader 27 are possible and contemplated.

FIG. 2A illustrates an exemplary cartridge 224 including a cleaning brush 200 fixed to a flexible member such as cartridge leader 228 or tape 226, and FIG. 2B illustrates a cross-sectional view of a portion of the cartridge leader 228 and/or tape 226 including the cleaning brush 200 fixed thereto.

Cartridge leader 228 may include any flexible carrier material and is generally formed of a thicker, more durable material than tape portion 226. Cartridge leader 228 may further include a portion having one or more leader holes 212, which may be used by the drive to identify the cartridge as a cleaning cartridge, or at least as including cleaning brush 200. Additionally, a leader buckle (not shown) may be included at the distal end of cartridge leader 228.

Tape portion 226 may be in the form of magnetic and/or optical storage tape, or merely a flexible carrier for cleaning brush 200. It is noted that in other examples, conventional cartridges may be equipped with a cleaning brush 200 located with a single flexible member such as cartridge leader 228 or tape portion 226 (i.e., without the presence of both a leader portion and tape portion).

In instances where tape portion 226 includes a storage medium, data may be read and/or written to tape portion 226, e.g., in a directory area, for identifying and controlling the use of cartridge 224 having cleaning brush 200. For example, the drive may identify the cartridge as including a cleaning brush 200 based on information written to a portion of tape portion 226, and may also write data associated with the number of cleanings, time or load count of previous cleaning processes, and the like. Some illustrative operating examples are described in copending U.S. patent application Ser. No. 10/820,388, entitled “METHODS FOR CONTROLLING THE USE OF A CLEANING CARTRIDGE FOR TAPE DRIVES”, filed Apr. 7, 2004, the entire content of which is incorporated herein by reference.

It should be understood that cleaning brush 200 and cartridge leader 228 are shown in an extended position from cartridge 224 for illustrative purposes and that cleaning brush 200 and cartridge leader 228 may be wound within the housing of cartridge 224 on a rotatable cartridge reel. Accordingly, in this example, cleaning brush 200 is sufficiently flexible to be wound on a reel within the housing of cartridge 224.

Cartridge 224 may be received by a tape drive (e.g., tape drive 10 of FIG. 1) and a leader pin or the like associated with cartridge leader 228 may be coupled to a drive leader via a buckle mechanism and drawn or streamed from cartridge 224. Cartridge leader 228 and/or tape 226 are drawn or streamed through the drive until cleaning brush 200 is moved to a position adjacent the drive head. Cleaning brush 200 contacts and may be moved over the drive head to remove debris as described herein. Additionally, the drive head may be moved relative to the cleaning brush 200 to remove debris as described herein.

In one example, a tape drive such as tape drive 10 shown in FIG. 1 includes a controller operable to position cleaning brush 200 adjacent the drive head for a cleaning process. As described, the controller may further be operable to move the drive head relative to cleaning brush 200. The controller may therefore include one or more cleaning algorithms for controlling and using cartridge 224 and cleaning brush 200.

Exemplary methods and algorithms for positioning a cleaning brush and handling cartridges may be carried out in software, firmware, hardware, or combinations thereof and included, e.g., in at least one of the tape drive and associated computer system or network. The exemplary methods may also be included in a computer readable storage medium containing computer executable code.

FIG. 2B illustrates a cross-sectional view of a portion of cleaning brush 200 and a portion of cartridge leader 228 or tape portion 226. Cleaning brush 200 includes a plurality of bristles 201 oriented substantially away from the plane of the cartridge leader 228 or tape 226. Further, in this example, the bristles 201 are supported by layer 218. Layer 218 may include a backing of which bristles 201 are woven or sewn into. Layer 218 may also include an adhesive to fixedly support bristles 201 as well as fix the cleaning brush 200 to cartridge leader 228 or tape 226. In other examples an additional layer of adhesive may be disposed between layer 218 and the cartridge leader 228 and tape 226. In yet other examples, bristles may be woven directly into a flexible member such as cartridge leader 228 or tape 226. Various other techniques of forming cleaning brush 200 having a plurality of bristles 201 are possible.

The bristles 201 of cleaning brush 200 may include one or more materials such as synthetic fibers, carbon, stainless steel, or the like. In one example the material of bristles 201 includes electrically conductive or statically dissipative materials. Electrically conductive or statically dissipative materials may avoid static discharge when contacting a drive head (which may damage transducer elements of the drive head). One exemplary brush includes an acrylic fiber pad brush produced under the trademark name Thunderon™ (the acrylic fibers of the brush developed by Nihon Sanmo Dyeing Co., Ltd.). The cleaning brush may further be milled, cut, shaved, or otherwise reduced in height for a particular application or desired height.

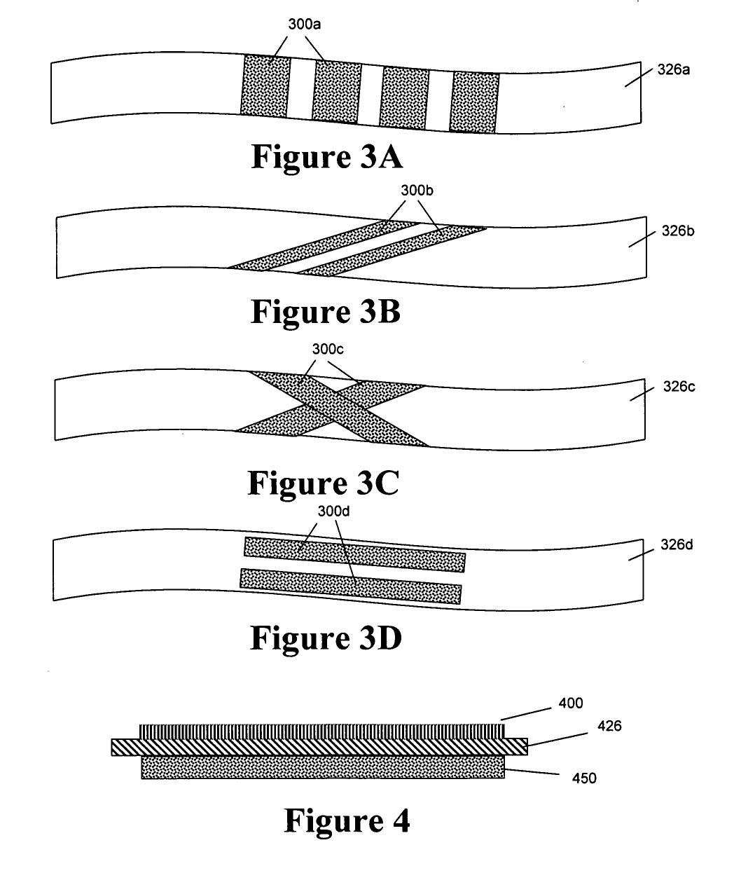

Cleaning brush 200 may be manufactured and fixed to a flexible member as a rectangular pad that is the full width of cartridge leader 228 or tape 226 (e.g., 0.5 inch wide and one or more inches in length for a conventional magnetic storage tape). In other examples, cleaning brush 200 may comprise one or more strips disposed linearly or diagonally with cartridge leader 228 or tape portion 226, thereby covering only partial areas of cartridge leader 228 or tape portion 226 (see, e.g., FIGS. 3A-3D for some illustrative examples). The longitudinal length of cleaning brush 200 may also be varied to facilitate alignment with the tape drive head, for example.

In one example, multiple cleaning brushes 200 (whether identical or different) may be positioned along the length of cartridge leader 228 and/or tape portion 226 to facilitate multiple cleaning processes (see, e.g., FIG. 3A). For example, a first cleaning brush may be skipped after a certain number of cleaning processes for a less used cleaning brush. Additionally, cleaning brushes of different heights, or having bristles of different stiffness, diameters, materials, etc., or positioned with different densities, may be included and selected for a particular drive head and/or desired cleaning process. Various other incorporations of one or more cleaning brushes and schemes are possible and contemplated.

In one example, the diameter and height “H” of bristles 200 of cleaning brush 200 are sufficient to reach into the grooves and slots of a drive head to remove debris therefrom. Additionally, a relatively low profile may also be desired to ensure the cleaning brush is sufficiently flexible and thin to move through the drive without causing drive errors or the like, e.g., to fit clearances such as between the drive head and an opposing optical or magnetic servo assembly. Accordingly, the dimensions of cleaning brush 200 may vary depending on the particular drive head characteristics and drive tape path. In one example, the height “H” of cleaning brush 200 and bristles 201 is less than 0.1 inches. In another example, the height is about 0.05 inches; in another example, equal to or less than 0.05 inches, and in another example, equal to or less than 0.03 inches.

The diameter of bristles 201 may vary depending on the particular gap width (i.e., the groove or slot) dimensions of the tape drive head. In one example, the diameter of individual bristles is approximately equal to or less than the gap widths of the grooves or slots of the tape head. In another example, the bristle diameter is equal to or less than 0.9 times the gap widths of the tape head; and in another example, equal to or less than 0.8 times the gap widths of the tape head.

FIGS. 3A-3D illustrates various configurations of cleaning brushes 300a-300d fixed to flexible members 326a-326d respectively, where flexible members 326a-326d may include a tape portion or leader portion associated with a cartridge or tape drive. As illustrated, various patterns and configurations are possible and contemplated. Further, the longitudinal dimension of the cleaning brush may vary, e.g., from a half inch to many inches or the entire length of the drive leader, cartridge leader, or tape within a cartridge.

Additionally, a cleaning brush may be fixed to opposing sides of the flexible member. For example, a cleaning brush similar to cleaning brushes 300a-300d may be included on the backside of flexible members 300a-300d, thereby being capable of cleaning heads or other drive portions on either side of the flexible members 300a-300d as they move through the drive.

FIG. 4 illustrates a cross-sectional view of another exemplary cleaning apparatus having two or more cleaning members. In this example, the apparatus includes a flexible member 426, e.g., a tape and/or leader portion, having a cleaning brush 400 affixed to a first side of flexible member 426 and a second cleaning member 450 fixed to an opposite second side of flexible member 426.

Cleaning brush 400 may include a cleaning brush comprising a plurality of bristles similar to cleaning brush 200 described with reference to FIGS. 2A and 2B; however, cleaning member 450 includes a pad material such as cloth or the like suitable for cleaning features associated with an optical servo assembly (which is typically positioned opposite the drive head). Accordingly, as cleaning brush 400 is positioned to clean a drive head, cleaning member 450 may clean components of the optical servo assembly (e.g., the focalizer). Similar to cleaning brush 400, cleaning member 450 is similarly flexible with a low profile (e.g., less than 0.2 inches). Cleaning brush 400 and cleaning member 450 may advantageously be incorporated together to provide a cleaning brush for the media head and a cleaning member suitable for an optical servo system in a single cleaning cartridge (or a single drive leader).

The above detailed description is provided to illustrate exemplary embodiments and is not intended to be limiting. It will be apparent to those skilled in the art that numerous modifications and variations within the scope of the present invention are possible. Throughout this description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

1. A cartridge for use with a tape drive, comprising:
a flexible member; and
a cleaning brush attached to the flexible member, wherein the cleaning brush includes a plurality of bristles.

2. The apparatus of claim 1, wherein the cleaning brush is flexible.

3. The apparatus of claim 1, wherein the flexible member comprises a cartridge leader.

4. The apparatus of claim 1, wherein the flexible member comprises a tape portion.

5. The apparatus of claim 1, wherein the bristles have a height relative to the flexible member of less than 0.1 inches.

6. The apparatus of claim 1, wherein the bristles have a height relative to the flexible member of equal to or less than 0.05 inches.

7. The apparatus of claim 1, wherein the bristles comprise an electrically conductive material.

8. The apparatus of claim 1, further comprising a cleaning member positioned on a side of the flexible member opposite the cleaning brush.

9. The apparatus of claim 1, wherein the flexible member and the cleaning brush are wound on a cartridge reel and operable to be drawn out of a cartridge housing.

10. A tape drive, comprising:
a data transducer drive head;
a drive leader; and
a controller, the controller comprising logic operable to move the drive leader and position a flexible cleaning brush in contact with at least a portion of the drive head, wherein the cleaning brush comprises a plurality of bristles.

11. The tape drive of claim 10, wherein the cleaning brush is attached to the drive leader.

12. The tape drive of claim 11, wherein the logic operable to move the cleaning brush includes moving the drive leader until the cleaning brush contacts at least a portion of the drive head.

13. The tape drive of claim 10, wherein the flexible cleaning brush is associated with a flexible member of a cartridge, and the logic operable to move the cleaning brush includes moving the drive leader to draw the flexible member from the cartridge until the cleaning brush contacts at least a portion of the drive head.

14. The tape drive of claim 13, wherein the flexible member of the cartridge includes a cartridge leader or a tape portion.

15. The tape drive of claim 10, further comprising a controller comprising logic operable to move the transducer head when the cleaning brush contacts the drive head.

16. The tape drive of claim 10, wherein the bristles have a height relative to the drive leader of less than 0.1 inches.

17. The tape drive of claim 10, wherein the bristles have a height relative to the drive leader equal to or less than 0.05 inches.

18. The tape drive of claim 10, wherein the bristles comprise an electrically conductive material.

19. The tape drive of claim 10, further comprising a cleaning member positioned on a backside of the cleaning brush.

20. A method for cleaning a data transducer head of a tape drive, the method comprising:
moving a flexible cleaning brush through the tape drive, the cleaning brush including a plurality of bristles; and
contacting at least a portion of a data transducer head of the tape drive with the bristles.

21. The method of claim 20, wherein the flexible member comprises a cartridge leader.

22. The method of claim 20, wherein the flexible member comprises a tape member of a cartridge.

23. The method of claim 20, wherein the flexible member comprises a drive leader.

24. The method of claim 20, wherein the bristles have a height relative to the flexible member of less than 0.1 inches.

25. The method of claim 20, wherein the bristles have a height relative to the flexible member of equal to or less than 0.05 inches.

26. The method of claim 20, wherein the flexible member and the cleaning brush are wound on a cartridge reel and streamed from the cartridge housing to the data transducer head.

27. The method of claim 20, further including moving the data transducer head when the cleaning brush is positioned adjacent the data transducer head.
